(19) United States
(12) Patent Application Publication
(10) Pub. No.: US 2020/0119985 A1
(43) Pub. Date: Apr. 16, 2020

(54) CHANGING SECURITY STATE OF DEVICE

(71) Applicant: HEWLETT PACKARD ENTERPRISE DEVELOPMENT LP, Houston, TX (US)

(72) Inventors: Robert D. Matthews, Houston, TX (US); John Meyer, Houston, TX (US); Luis Luciani, Houston, TX (US)

(21) Appl. No.: 16/159,965

(22) Filed: Oct. 15, 2018

(51) Int. Cl. H04L 12/24; G06F 9/54; H04L 9/08; H04L 29/06

(52) U.S. Cl. CPC H04L 41/0813; H04L 63/205; H04L 9/088; G06F 9/541

(57) ABSTRACT

Examples disclosed herein relate to a device that has a chassis that can transition from a factory security state to a production security state. A visible object can be removed from the outside of the chassis to trigger the change in state. A BMC can change the state from the factory security state to the production security state based on detection of a physical trigger. The factory security state includes an application programming interface (API) that is enabled and the production security state has the API disabled.

### BACKGROUND

Service providers and manufacturers are challenged to deliver quality and value to consumers, for example by providing secure computing devices and computing capabilities to consumers. A data center is a facility used to house computer networks, computer systems, and associated components, such as telecommunications and storage systems. Equipment in a data center may be in the form of servers mounted in rack cabinets.

### BRIEF DESCRIPTION OF THE DRAWINGS

The following detailed description references the drawings, wherein:

FIGS. 1 and 2 are block diagrams of computing devices capable of changing a security state of a computing device from a factory security state to a production security state based on detection of a physical trigger, according to various examples;

FIG. 3 is a flowchart of a method for changing, by a baseboard management controller, a security state of a device from a factory security state to a production security state upon detection of a physical trigger, according to an example;

FIG. 4 is a block diagram of a device including a baseboard management controller to change a security state of the device from a factory security state to a productions security state upon detection of a physical trigger, according to an example; and

FIG. 5 is an illustration of devices with a visible object connected to the inside of a chassis of each device that can trigger a change from a factory security state to a production security state, according to an example.

Throughout the drawings, identical reference numbers may designate similar, but not necessarily identical, elements. An index number “N” appended to some of the reference numerals may be understood to merely denote plurality and may not necessarily represent the same quantity for each reference numeral having such an index number “N”. Additionally, use herein of a reference numeral without an index number, where such reference numeral is referred to elsewhere with an index number, may be a general reference to the corresponding plural elements, collectively or individually. In another example, an index number of “I,” “M,” etc. can be used in place of index number N.

### DETAILED DESCRIPTION

When a computing device such as a server is assembled and begins the factory process, it can be in a factory security state. This factory security state allows access to information and programming of data on the computing device in order to prepare it to ship to a customer. This can allow for security parameters such as management passwords to be written and read. In some examples, the factory security state can be used for, license confirmation, factory initialization of components within a device chassis, testing devices using direct access, verifying and recording inventory of devices and/or settings in the device, etc. Once the computing device has completed the factory process, the computing device is put into a production security state. This can lock and prevent access to password and other information on the computing device by limiting capabilities to access these features. This can be the desired security state to harden the computing device for field use. Thus, the device is more secure in the production security state.

Unfortunately, there are cases where a device is built, set into the production security state, but then does not ship to a customer. This could be caused by a customer order being cancelled. In other examples this can be done because the build was done as part of a pilot process. Additionally, in order to prevent accidental shipment of a server in the factory security state, some automated protections can be put in place, for example, after some number of power cycles, a device can automatically move into the production security state.

This approach would trust that factory operators carefully process the computing device to make sure it does not switch states by mistake. The method to get the device back into the factory security state is expectedly very difficult. Particular security measures can be implemented such that the factory security state cannot be returned to unless proof is provided that a user is authorized, for example, by using a manufacturing key. In some examples, the security measure may also require some proof of location (e.g., a manufacturing location of the manufacturer). Thus, it can be a costly and time consuming process to revert the device back into the factory security state.

Accordingly, various examples provided herein describe a method to use a physical visible object, such as a visible pull tag to set the server to production security state. The object or tag would be visible and provide a visual indicator that the device is not ready to be shipped. When devices are built in the factory, this tag can remain installed until the device is ready to be packed for shipment. This would allow the device to easily be re-processed, but still prevent the accidental shipment of a server in the factory security state to a customer.

The physical visible object, such as a pull tag would be accessible from outside of the computing device. This would allow access to remove the tag without opening the computing device. Additionally, the visible object can provide an indicator of the security state of the device. The physical tag would also simplify the routing of devices in the factory. Some devices may go into audit, or move forward into solutions configurations. Using the physical visible object would simplify the processing of those later factory stations and reduce the risk of accidently shipping a device that was not in the correct production security state.

With the approaches described herein, the visible object helps a factory worker determine if a device has been placed into the production security state. Moreover, the visible object can be left in place on the device until packaging to allow for re-processing at limited cost. The visible object approach also limits the number of accidental switches into the productions security state. Re-processing a device which has been switched from a factory security mode to a production security mode can be costly. This can be, for example, because a person would need to manually use tools to reset the device to the factory security state using particular credentials.

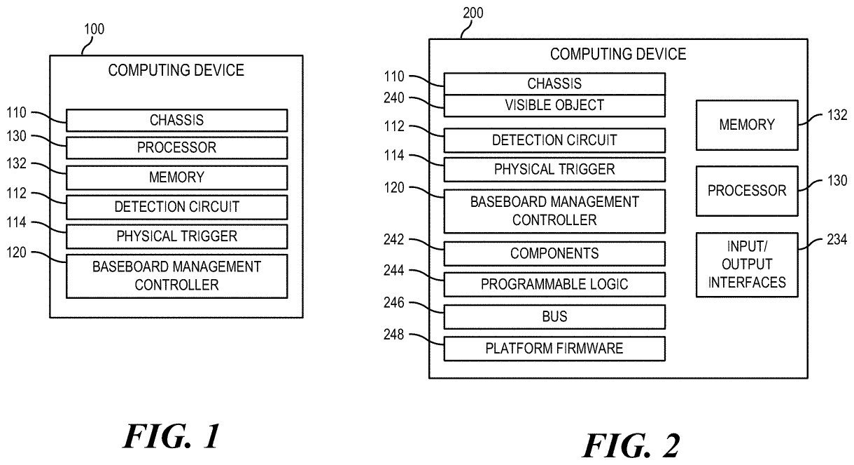

FIGS. 1 and 2 are block diagrams of computing devices capable of changing a security state of a computing device from a factory security state to a production security state based on detection of a physical trigger, according to various examples. Computing devices 100, 200 include components that can be utilized to transition the computing device from a factory security state to a production security state. The respective computing devices 100, 200 may be a server, notebook computer, a desktop computer, a node of a server device, a blade, a rack server, a tablet computing device, a wireless device, a workstation, or any other computing device that includes the functionality described herein. Computing device 100 includes a chassis 110, a detection circuit 112, a physical trigger 114, a baseboard management controller (BMC) 120, a processor 130, and memory 132. Computing device 200 further includes a visible object 240, components 242, programmable logic 244, a bus 246, platform firmware 248, and input/output interfaces 234.

As used herein, a chassis 110 is the outer structural framework of a computing device 100, 200. The chassis 110 can include components 242, the detection circuit 112, the physical trigger 114, the BMC 120, programmable logic 244 such as a field programmable gate array (FPGA) or complex programmable logic device (CPLD), devices to store platform firmware 248, busses such as bus 246, memory 132, processors 130, etc.

A visible object 240 can be placed on the outside of the chassis 110 and be connected to the physical trigger 114 on the inside of the chassis 110. The visible object 240 can be implemented as a physical tag. The physical tag can contrast in color from the chassis 110 to allow for easy determination by a worker that the physical tag is in place. For example, a red, white, or yellow tag may be used fora grey chassis. Other objects can be used.

In some examples, the physical tag, when pulled off of the chassis 110, triggers the physical trigger 114. The physical trigger 114 can be within the chassis 110 while the connected visible object 240 is primarily outside of the chassis 110. To be considered a visible object outside of the chassis 110, a portion of the visible object 240 would be required to be outside of the chassis 110. This would still be considered outside even if another portion of the visible object is connected to the physical trigger 114 within the chassis 110.

In one example, the physical trigger 114 can be implemented similar to a battery compartment in a toy, where a spring is used to close two contacts when plastic is removed. In another example, a switch can be triggered in a different way. Moreover, in some examples, components of a server lid opening intrusion circuit can be used to perform some of the functionality of the trigger. Moreover, in some examples, once the trigger has been set, it cannot be easily unset (similar to an intrusion detection circuit). For example, once the physical trigger 114 has been triggered, the detection circuit 112 can detect that it has been triggered and set a general purpose input output to a setting. In some examples, this can work even if the device is not plugged in (e.g., using a battery backup system, a capacitor that gets drained once the tag is removed, etc.).

The BMC 120 can detect that the physical trigger 114 has been triggered. In some examples, the detection circuit 112 is implemented within the BMC 120. In other examples, the detection circuit 112 can be implemented outside of the BMC 120. In some examples, the detection circuit 112 can be connected to a general purpose I/O of programmable logic 244 that the BMC 120 monitors. In other examples, the BMC 120 can be connected directly. In some examples, the computing device 200 can be plugged in and the BMC 120 can detect the trigger when it is triggered. In other examples, the computing device 200 may not have power, including standby power, and the BMC 120 can perform the change in security states when the computing device 200 receives auxiliary power.

The BMC 120 can be implemented to change from a factory security state to a production security state in response to the detection that the physical trigger 114 has been engaged by the detection circuit 112. In some examples, the BMC 120 can implement the change using a write once register. The write once register can be implemented, for example, using fuses. In some examples a fuse is a component of the BMC 120 that once triggered cannot be reset. In some examples, once programmed, the ability to change the registers is disabled (e.g., severing a fuseable link, for example, on a write line). In other examples, the setting (e.g., a write once register, a fuse, etc.) used to determine the change, is a component of other logic or memory such as an FPGA, a CPLD, an electrically erasable programmable read-only memory (EEPROM), etc. In some examples, the component or other logic is set by the circuit directly. In other examples, the component or other logic is set by the BMC 120. The BMC 120 can use that setting to determine the security state of the computing device 100, 200. In one example, the fuse is used to take the computing device 100, 200 out of the factory security state and into the production security state. In this example, the computing device 100, 200 cannot return to the factory security state without performing a security feature. In one example, the security feature can include using a manual firmware tool in conjunction with a cryptographic key. In some examples, to return to the security state, the firmware tool can require proof of location within a factory (e.g., via a cryptographic key or other secret known by the manufacturer and shared with the BMC). The key information can be securely stored by the manufacturer. The security feature can be intentionally difficult to perform. Accordingly, in some examples, once the setting is set to the production security state, even if the trigger is reset, the setting does not revert back to the referring to the factory security state.

When the security state changes, the BMC 120 can disable particular APIs available in the factory security state. In some examples, the disabling can include deleting access to functionality in the BMC 120 and/or disabling based on security permissions. Further, in some examples, the BMC 120 can change other settings in other components 242 or platform firmware 248 to disable one or more associated APIs.

In one example, a factory security state includes a plurality of application programming interfaces (API) that are enabled. As used herein, the production security state has at least one of these APIs disabled. The specific APIs can relate to functionality that may be needed to configure a computing device 100, 200 in the factory, but may be unwanted (e.g., for security reasons) when the computing device 100, 200 is at a customer site.

In one example, the API is associated with an initialization of one or multiple components 242 inside of the chassis 110. This can, include, for example, direct access to a bus 246 that other components 242 connected to the BMC 120 are connected. Direct access to the bus 246 can include, for example, an API that allows for a clear text reading of transactions occurring on the bus 246. This can be different, for example, from providing an API to communicate with a particular component 242 on the bus 246 and provide a particular response from the component 242 or other functionality of an API that would abstract the bus communications.

In another example, the API can be associated with a verification and recording of inventory of a plurality of components 242 of the computing device 200 and/or one or more settings of the components 242. Examples of components 242 can include platform firmware 248 to be executed on a processor 130, a storage controller, an Input/output (IO) controller, a super IO controller, a northbridge, a southbridge, other management controllers associated with other peripherals on the computing device 200, memory controllers, etc. Verification and recording can include communicating with each of the components 242 to record specific information, for example, a serial number or other unique identifier, other setting information, etc. of the respective components. In some examples, this information can be used to provide a fingerprint of the computing device 200 and to perform security actions to ensure proper execution of the computing device 200. This can be used, for example, to ensure that proper verified firmware and/or components 242 are present on the computing device 200.

In another example, one of the APIs can include an API associated with testing of one or multiple components of the computing device 200. APIs in this class may be associated with verification that the components 242 can perform to a certain level. These APIs may execute past a specification metric for testing purposes. Thus, it can be beneficial for some APIs in this class to be disabled while the computing device 200 is at a client site.

In some examples, the BMC 120 can be used to implement services for the computing device 100, 200. BMC 120 can be implemented using a separate processor from the processor 130 that is used to execute a high level operating system. BMCs can provide so-called “lights-out” functionality for computing devices. The lights out functionality may allow a user, such as a systems administrator, to perform management operations on the computing device 100, 200 even if an operating system is not installed or not functional on the computing device 100, 200. Moreover, in one example, the BMC 120 can run on auxiliary power, thus the computing device 100, 200 need not be powered on to an on state where control of the computing device 100, 200 is handed over to an operating system after boot. As examples, the BMC 120 may provide so-called “out-of-band” services, such as remote console access, remote reboot and power management functionality, monitoring health of the system, access to system logs, and the like.

As noted, in some instances, the BMC 120 may enable lights-out management of the computing device 100, 200, which provides remote management access (e.g., system console access) regardless of whether the computing device 100, 200 is powered on, whether a primary network subsystem hardware is functioning, or whether an OS is operating or even installed. The BMC 120 may comprise an interface, such as a network interface, and/or serial interface that an administrator can use to remotely communicate with the BMC 120. As used herein, an “out-of-band” service is a service provided by the BMC 120 via a dedicated management channel (e.g., the network interface or serial interface) and is available whether the computing device 100, 200 is in powered on state.

In some examples, a BMC 120 may be included in one or more of the servers (e.g., as part of the management subsystem of the server) or connected via an interface (e.g., a peripheral interface). In some examples, sensors associated with the BMC 120 can measure internal physical variables such as humidity, temperature, power supply voltage, communications parameters, fan speeds, operating system functions, or the like. The BMC 120 may also be capable to reboot or power cycle the device. As noted, the BMC 120 allows for remote management of the device, as such, notifications can be made to a centralized station using the BMC 120 and passwords or other user entry can be implemented via the BMC 120.

In some examples, platform firmware 248 can be implemented using instructions executable by a processor and/or logic. In some examples, the firmware engine can be implemented as platform firmware 248. Platform firmware 248 may include an interface such as a basic input/output system (BIOS) or unified extensible firmware interface (UEFI) to allow it to be interfaced with. The platform firmware 248 can be located at an address space where the processor (e.g., CPU) for the computing device 100, 200 boots. In some examples, the platform firmware 248 may be responsible for a power on self-test for the computing device 100, 200. In other examples, the platform firmware can be responsible for the boot process and what, if any, operating system to load onto the computing device 100, 200. Further, the platform firmware 248 may be capable to initialize various components of the computing device 100, 200 such as peripherals, memory 132, memory controller settings, storage controller settings, bus speeds, video card information, etc.

In one example, an entity (e.g., an automatic process during the manufacturing process or user putting the system into a mode (e.g., a secure transit mode, a secure rest mode, etc.)) in which a digital inventory of the computer system is created by a firmware component (e.g., a Basic Input Output System (BIOS), a Baseboard Management Controller (BMC), other firmware components, etc.) and securely stored. In this example, the digital inventory is then checked on each and the BMC/platform firmware can indicate if the inventory has changed. A change in the inventory indicates that the system has been modified in some way.

The digital inventory can take multiple forms. In the one example, the digital inventory can include creating a hash (e.g., using a modern, industry standard hashing algorithm) which includes a number of items to be protected. In one example, the items can include all industry standard PCIe configuration space for all PCIe devices installed in the system. In another example, the items can include unique identifier information (e.g., serial numbers) from installed dual inline memory modules (DIMMs). In a further example, the items can include a unique identifier available in a processor. In some examples, this value is not modifiable and is unique to each individual processor. In a further example, the items can include configuration settings for firmware. This can include, for example, security settings and a Secure Boot Key database. In some examples all configuration settings can be inventoried. In other examples, a subset of the configuration settings (e.g., settings associated with security, updates, hardware components, etc.) can be inventoried. Further, firmware revisions for installed firmware (e.g., BIOS, BMC firmware, power supply firmware, controller hub firmware, custom Application Specific Integrated Circuit (ASIC) versions, etc.) on the system board or elsewhere on the computing system can be inventoried. In some examples, it can be beneficial to include certain inventory approaches available while the computing device 100, 200 is in the factory, but not available when the computing device 100, 200 is in production.

Various components used in the computing device 100, 200 can be implemented as engines. Engines can include hardware and/or combinations of hardware and programming to perform functions provided herein.

A processor 130, such as a central processing unit (CPU) or a microprocessor suitable for retrieval and execution of instructions and/or electronic circuits can be configured to perform various functionality discussed herein. In certain scenarios, instructions and/or other information, can be included in memory 132 or other memory. Input/output interfaces 234 may additionally be provided by the computing device 200. For example, input devices, such as a keyboard, a sensor, a touch interface, a mouse, a microphone, etc. can be utilized to receive input from an environment surrounding the computing device 200. Further, an output device such as a display, can be utilized to present information to users. Examples of output devices include speakers, display devices, amplifiers, etc. Moreover, in certain examples, some components can be utilized to implement functionality of other components described herein. Input/output devices such as communication devices like network communication devices or wireless devices can also be considered devices capable of using the input/output interfaces 234.

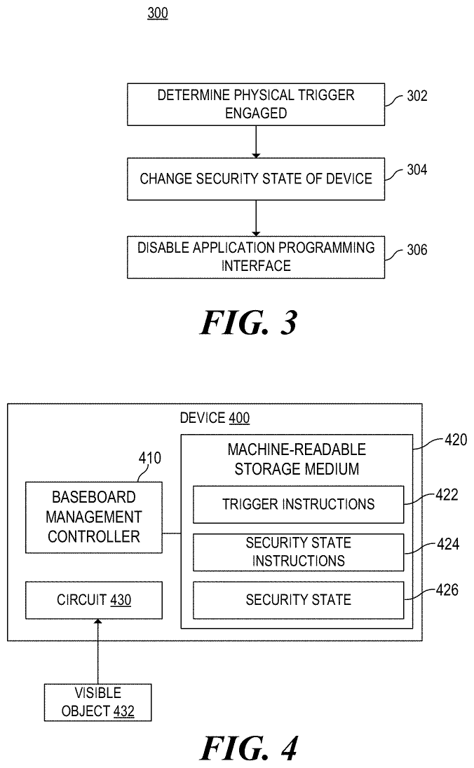

FIG. 3 is a flowchart of a method for changing, by a baseboard management controller, a security state of a device from a factory security state to a production security state upon detection of a physical trigger, according to an example. FIG. 4 is a block diagram of a device including a baseboard management controller to change a security state of the device from a factory security state to a productions security state upon detection of a physical trigger, according to an example. The device 400 includes, for example, a BMC 410 including a processing element and a machine-readable storage medium 420 including instructions 422, 424, 426 for transitioning the device 400 into a production security sate from a factory security state.

Processing element may be, one or multiple central processing unit (CPU), one or multiple semiconductor-based microprocessor, one or multiple graphics processing unit (GPU), other hardware devices suitable for retrieval and execution of instructions stored in machine-readable storage medium 420, or combinations thereof. The processing element can be a physical device. Processing element may fetch, decode, and execute instructions 422, 424, 426 to implement the transition in security states. As an alternative or in addition to retrieving and executing instructions, processing element may include at least one integrated circuit (IC), other control logic, other electronic circuits, or combinations thereof that include a number of electronic components for performing the functionality of instructions 422, 424, 426.

Machine-readable storage medium 420 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 420 may be encoded with a series of executable instructions for performing method 300.

During the manufacturing process, once the device 400 is ready to ship, a visible object 432 can be removed from the device 400. As noted above, the device can include a chassis, where the visible object 432 is outside of the chassis and a circuit 430 that is used to detect that a trigger has been engaged is within the chassis.

At 302, the BMC 410 can execute trigger instructions 422 to determine that a physical trigger has been engaged. This can be in response to the visible object 432 being removed. As noted above, the BMC 410 can be a processor that is separate than a host processor that is used to execute a higher level operating system on the device 400.

At 304, in response to the detection that the physical trigger has been engaged, the BMC 410 can execute security state instructions 424 to change the security state 426 from a factory security state to a production security state. As noted above, the change in security state includes disabling of at least one API (306). As noted above, the factory security state includes at least one API that is enabled and one or more of those APIs are disabled in the production security state.

The BMC 410 can be implemented to change from a factory security state to a production security state in response to the detection that the physical trigger has been engaged by the detection circuit 430. In some examples, the BMC 410 can implement the change using a write once register. The write once register can be implemented, for example, using fuses. In some examples a fuse is a component of the BMC 410 that once triggered cannot be reset. In some examples, once programmed, the ability to change the registers is disabled (e.g., severing a fuseable link, for example, on a write line). The BMC 410 can use that setting to determine the security state of the device 400. In one example, the fuse is used to take the device 400 out of the factory security state and into the production security state. In this example, the computing device 400 cannot return to the factory security state without performing a security feature.

In one example, the security feature can include using a manual firmware tool in conjunction with a cryptographic key. In some examples, to return to the security state, the firmware tool can require proof of location within a factory (e.g., via a cryptographic key or other secret known by the manufacturer and shared with the BMC). The key information can be securely stored by the manufacturer. The security feature can be intentionally difficult to perform.

When the security state changes, the BMC 410 can disable particular APIs available in the factory security state. In some examples, the disabling can include deleting access to functionality in the BMC 410 and/or disabling based on security permissions. Further, in some examples, the BMC 410 can change other settings in other components or platform firmware to disable one or more associated APIs.

In one example, a factory security state includes a plurality of application programming interfaces (API) that are enabled. As used herein, the production security state has at least one of these APIs disabled. The specific APIs can relate to functionality that may be needed to configure a computing device 400 in the factory, but may be unwanted (e.g., for security reasons) when the computing device 400 is at a customer site.

In one example, the API is associated with an initialization of one or multiple components inside of the chassis. This can, include, for example, direct access to a bus that other components connected to the BMC 410 are connected. The connection to the BMC 410 need not be direct. Direct access to the bus can include, for example, an API that allows for a clear text reading of transactions occurring on the bus. This can be different, for example, from providing an API to communicate with a particular component on the bus and provide a particular response from the component or other functionality of an API that would abstract the bus communications.

In another example, the API can be associated with a verification and recording of inventory of a plurality of components of the computing device 400 and/or one or more settings of the components. Examples of components can include platform firmware to be executed on a processor, a storage controller, an Input/output (IO) controller, a super IO controller, a northbridge, a southbridge, other management controllers associated with other peripherals on the device 400, memory controllers, etc. Verification and recording can include communicating with each of the components to record specific information, for example, a serial number or other unique identifier, other setting information, etc. of the respective components. In some examples, this information can be used to provide a fingerprint of the device 400 and to perform security actions to ensure proper execution of the device 400. This can be used, for example, to ensure that proper verified firmware and/or components are present on the device 400.

In another example, one of the APIs can include an API associated with testing of one or multiple components of the device 400. APIs in this class may be associated with verification that the components can perform to a certain level. These APIs may execute past a specification metric for testing purposes. Thus, it can be beneficial for some APIs in this class to be disabled while the device 400 is at a client site.

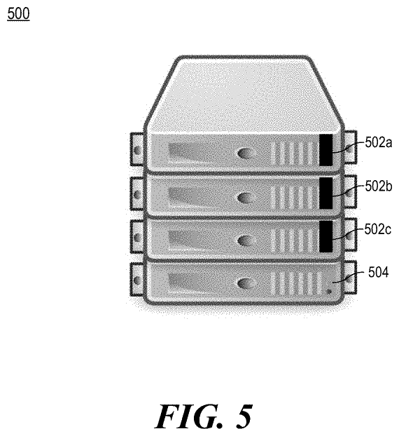

FIG. 5 is an illustration of devices with a visible object connected to the inside of a chassis of each device that can trigger a change from a factory security state to a production security state, according to an example.

Diagram 500 includes 4 devices. Three devices in the diagram 500 include a visible object 502a, 502b, 502c. The fourth device has the visible object removed at 504. As such, the fourth device can be in a state ready to ship from a manufacturing site while the first three devices are not. Though shown using a black tag on a grey chassis, implementation can use bright colors to stand out from the chassis. Though the location of the visible objects are on the front of these diagrams, other locations of the chassis can be used. Moreover, in some examples, the visible object can include a piece or attached part that can go in between a seam in the chassis to attach to the trigger. In some examples, the visible object is made out of a plastic material.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A computing device comprising:
a chassis;
at least one processor and memory;
a baseboard management controller (BMC), separate from the at least one processor, that is capable of providing out of band services;
a circuit to detect that a physical trigger has been engaged, wherein the physical trigger is connected to a visible object on an outside of the chassis;
wherein the BMC is to change from a factory security state to a production security state in response to the detection that the physical trigger has been engaged,
wherein the factory security state includes an application programming interface (API) that is enabled and the production security state has the API disabled.

2. The computing device of claim 1, wherein the physical trigger is engaged by removal of the visible object from the outside of the chassis, wherein the physical trigger is on an inside of the chassis.

3. The computing device of claim 1, wherein the API is associated with an initialization of one or multiple components located inside of the chassis.

4. The computing device of claim 1, wherein the BMC is to engage a fuse as part of the change to the production security state.

5. The computing device of claim 4, wherein the fuse is to take the computing device out of the factory security state and into the production security state where the computing device cannot be returned to the factory security state without using a manual firmware tool in conjunction with a cryptographic key.

6. The computing device of claim 1, wherein the API is associated with a verification and recording inventory of a plurality of components of the computing device and one or more settings of the components.

7. The computing device of claim 1, wherein the API is associated with a testing of multiple components of the computing device.

8. The computing device of claim 1, wherein the API is associated with a direct access to a bus of the computing device.

9. A non-transitory machine-readable storage medium storing instructions that, if executed by a baseboard management controller (BMC) of a device cause the BMC to:
determine that a circuit has detected that a physical trigger has been engaged, wherein the physical trigger is connected to a visible object on an outside of a chassis,
wherein the device includes the chassis and at least one processor, wherein the BMC is separate from the at least one processor, and wherein the BMC is capable of providing out of band services;
the BMC further to:
change the device from a factory security state to a production security state in response to the detection that the physical trigger has been engaged,
wherein the factory security state includes an application programming interface (API) that is enabled and the production security state has the API disabled.

10. The non-transitory machine-readable storage medium of claim 9,
wherein the physical trigger is engaged by removal of the visible object from the outside of the chassis, wherein the physical trigger is on an inside of the chassis.

11. The non-transitory machine-readable storage medium of claim 9,
wherein the API is associated with an initialization of one or multiple components located inside of the chassis.

12. The non-transitory machine-readable storage medium of claim 9,
wherein the API is associated with a verification and recording inventory of a plurality of components of the computing device and one or more settings of the components.

13. The non-transitory machine-readable storage medium of claim 9,
wherein the API is associated with a testing of multiple components of the computing device.

14. The non-transitory machine-readable storage medium of claim 9,
wherein the API is associated with a direct access to a bus of the computing device.

15. The non-transitory machine-readable storage medium of claim 9,
further comprising instructions that, if executed by the BMC, cause the BMC to:
engage a fuse as part of the change to the production security state.

16. The non-transitory machine-readable storage medium of claim 15,
wherein the fuse is to take the computing device out of the factory security state and into the production security state where return to the factory security state cannot be performed without using a manual firmware tool in conjunction with a cryptographic key.

17. A method comprising:
determining, at a baseboard management controller (BMC), that a circuit has detected that a physical trigger has been engaged, wherein the physical trigger is connected to a visible object on an outside of a chassis of a device,
wherein the device includes the chassis and at least one processor, wherein the BMC is separate from the at least one processor, and wherein the BMC is capable of providing out of band services;
changing, by the BMC, the device from a factory security state to a production security state in response to the detection that the physical trigger has been engaged by engaging a fuse,
wherein the factory security state includes an application programming interface (API) that is enabled and the production security state has the API disabled,
wherein the fuse is implemented to take the computing device out of the factory security state and into the production security state where return to the factory security state cannot be performed without using a manual firmware tool in conjunction with a cryptographic key.

18. The method of claim 17, further comprising:
engaging the physical trigger is by removal of the visible object from the outside of the chassis, wherein the physical trigger is on an inside of the chassis.

19. The method of claim 17,
wherein the API is associated with an initialization of one or multiple components located inside of the chassis.

20. The method of claim 17,
wherein the API is associated with a verification and recording inventory of a plurality of components of the computing device and one or more settings of the components.
